(19) United States
(12) Patent Application Publication
(10) Pub. No.: US 2025/0334208 A1
(43) Pub. Date: Oct. 30, 2025

(54) TENSION MOUNT IMPROVEMENTS

(71) Applicant: Air Diffusion Agencies Pty Ltd, Welland (AU)

(72) Inventor: William Trevor Threadgold, Welland (AU)

(21) Appl. No.: 19/260,108

(22) Filed: Jul. 3, 2025

Related U.S. Application Data
(63) Continuation of application No. 18/004,050, filed on Dec. 30, 2022, now Pat. No. 12,372,170.

(30) Foreign Application Priority Data
Jul. 2, 2020 (AU) 2020902257

(51) Int. Cl. F16L 3/202; F16L 3/18; F16L 3/24

(52) U.S. Cl. CPC F16L 3/202; F16L 3/18; F16L 3/243

(57) ABSTRACT

The present disclosure relates to a tension or hanging mount for engineering services, including but not limited to components of heating, ventilating, and air-conditioning (HVAC) systems. In one aspect, the tension mount comprises at least a base portion and a mount portion which depends from the base portion by hanging, wherein each of the base portion and the mount portion comprise a substantially rigid, nonflammable structural support element, and wherein at least one of these substantially rigid, non-flammable structural support elements is at least partially covered in a cushioning material in regions at or near to where the base portion and the mount portion are in contact with each other, and wherein in use, the mount portion is not dropped by the base portion even if the cushioning materials are consumed by a fire.

### CROSS-REFERENCE TO RELATED APPLICATIONS

This application a continuation of U.S. patent application Ser. No. 18/004,050, filed Dec. 30, 2022, which is a National Stage of International Application No. PCT/AU2021/000042, filed Jun. 30, 2021, which claims priority from Australian Provisional Patent Application No. 2020902257, titled “TENSION MOUNT IMPROVEMENTS,” and filed on Jul. 2, 2020, the contents of which are hereby incorporated by reference in their entirety.

### TECHNICAL FIELD

The present disclosure relates to a tension or hanging mount for engineering services. In a particular form, the present disclosure relates to a mount assembly for components of heating, ventilating, and air-conditioning (HVAC) systems.

### BACKGROUND

An air handling space in a building is a space between a structural ceiling and a dropped (or hung) ceiling. The air handling space is useful for housing components of heating, ventilating, and air-conditioning (HVAC) systems, such as those that provide pathways for and control of either heated/conditioned or return airflows, as well as electrical and data cabling and lighting equipment.

Thus there is a need to suspend this equipment from suitable tension or hanging mounts which depend from the structural ceiling.

In the event of seismic activity such as a tremor or an earthquake, it is critical that these tension mounts do not fail, and drop this equipment onto people below.

One means via which seismic resistance can be designed into these mounts is the use of cushioning or resilient materials between rigid components, to aid with the absorption of the shock loads and vibrations associated with seismic events.

A short coming of these cushioning or resilient materials is that they are generally flammable, meaning they can be consumed by fire, potentially resulting in failure of tension or hanging mounts, and the dropping or equipment suspended therefrom.

It is against this background and the problems and difficulties associated therewith that the present invention has been developed.

Certain objects and advantages of the present disclosure will become apparent from the following description, taken in connection with the accompanying drawings, wherein, by way of illustration and example, aspects of the present invention are disclosed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to a first aspect, there is provided a tension mount assembly comprising at least a base portion and a mount portion which depends from the base portion by hanging, wherein each of the base portion and the mount portion comprise a substantially rigid, non-flammable structural support element, and wherein at least one of these substantially rigid, non-flammable structural support elements is at least partially covered in a cushioning material in regions at or near to where the base portion and the mount portion are in contact with each other, and wherein in use, the mount portion is not dropped by the base portion even if the cushioning materials are consumed by a fire.

In one form, each of the substantially rigid, non-flammable structural support elements is at least partially covered in a cushioning material in regions at or near to where the base portion and the mount portion are in contact with each other.

In one form, the base portion comprises a body comprising an upperside and an underside, the upperside comprising a socket of a rounded shape formed therein, and the body further comprising a through aperture in the socket extending between the upperside and the underside of the body, the mount portion comprising an end portion comprising a bulbous shape, and a stem extending from the end portion, wherein the end portion of the mount portion nests in the socket of the base portion while the stem extends through the through aperture in the socket, the through aperture being sized to provide a clearance around the stem but too small for the bulbous shape to pass through.

In one form, the bulbous shape of the end portion of the mount portion comprises the shape of at least a portion of a sphere.

In one form, in an alternative, the bulbous shape is not spherical, but generally rounded. In one form then, the bulbous shape might be elliptical. In one form, the bulbous shape might be asymmetric.

In one form, the socket comprises a hemispherical shape.

In one form. the base portion further comprises a pair of bolt holes extending therethrough between the upperside and the underside of the body, there being one bolt hole to either side of the socket.

In one form, the mount portion comprises a rigid body comprising the stem, and an enlarged end portion so sized as to be unable to pass through the through aperture in the socket, and encapsulated in a cushioning material which is shaped to provide the bulbous form of the end portion of the mount portion.

In one form, the rigid body of the mount portion is formed from a non-flammable material.

In one form, the mount assembly further comprises a pair of bolts, and for each bolt a nut, where the bolts extend shank-first from an underside of the body of the base portion through the bolt holes, and where each bolt is secured by a nut positioned on the upperside of the body of the base portion.

In one form, the base portion comprises a load bearing support encapsulated in a cushioning material, both of which are shaped to provide the socket and through aperture.

In one form, the load bearing support of the base portion is formed from a non-flammable material.

In one form, the mount assembly further comprises a compression spring disposed over the shank of each of the bolts and between the head of each bolt and the load bearing support for the base portion.

The cushioning material comprises at least some cushioning properties. In one form, the cushioning material has at least some resilience. In one form, the cushioning material has at least some elastic properties.

According to a further aspect, there is provided a mount assembly comprising at least a base portion and a mount portion, wherein the base portion comprises a body comprising a load bearing support of non-flammable material encapsulated in a cushioning material, both of which cooperatively form a through aperture extending between an upperside and an underside of the body, and wherein the mount portion comprises a rigid body of non-flammable material comprising an enlarged end portion so sized as to be unable to pass through the through aperture in the base portion while the stem does so from the upperside with clearance therearound, and wherein at least the enlarged end portion of the mount portion is encapsulated in a cushioning material.

In one form, the enlarged end portion of the mount portion comprises a bulbous shape, and a stem extending from the end portion.

In one form, the body of the base portion comprises an upperside and an underside, the upperside comprising a socket of at least a hemispherical shape formed therein.

According to a further aspect, there is provided a mounting assembly comprising the above described mount assembly, and a rail upon which the base of the mount assembly is adapted to slide.

In one form, the rail comprises a channel comprising a slot. In one form, both the channel and the slot extend in a direction of elongation of the rail.

In one form, the rail comprises a floor, a pair of opposing sides, and an inwardly directed lip depending from each of the opposing sides.

In one form, the rail comprises a metal channel.

In one form, each of the nuts of the mount assembly is adapted to slidably engage in the slot of the rail so that the mount assembly is retained by the rail but able to slide therealong.

In one form, each of the nuts comprises a rectilinear planform body of a non-flammable material, the body comprising a pair of end edges, a pair of longer side edges, an upperside, an underside, a boss on the underside, and a threaded through hole extending between the upperside and the underside and through the boss for receiving the shank of one of the bolts.

In one form, each of the nuts comprises a stepped recess extending along the shorter side edges on the underside of the nut body.

In one form, the end edges of the nut body are shorter than the slot defined between the lips of the rail is wide, whereas the longer side edges are longer than the slot defined between the lips of the rail is wide.

In one form. for each nut there is a nut cover.

In one form, each nut cover comprises a body of a plastic material which is adapted to nest over the top of the nut, and retain the nut.

In one form, an underside of the nut cover comprises a recess sized and shaped to receive the nut therein, where each of the longer side edges of this recess comprise a retaining lip, which in use, is received with a snap-fit in a receiving groove provided along an underside, longer side edge of the nut.

In one form, in an alternative, the nut cover is overmolded onto the nut.

In one form, each of the upperside, longer side edges of the nut cover comprises one of a pair of upwardly and outwardly extending cantilever snaps extending upwardly therefrom.

In one form, the cantilever snaps can be employed to engage the nut assemblies with the lips of the rail for the purpose of temporarily suspending the mount assembly from the rail via the cantilever snaps during installation.

In one form, the stem of the mount portion comprises a blind hole extending inwardly from a stem end which is distal to the end plate, where inside of this blind hole there is retained a compression spring from which there depends an indicator cap that is visible through an inspection aperture in the stem when the compression spring is unloaded.

For ease of description, the mount and mounting assemblies embodying the present invention are described below in their usual assembled position as shown in the accompanying drawings and terms such as front, rear, upper, lower, horizontal, longitudinal etc., may be used with reference to this usual position. However, the mount and mounting assemblies may be manufactured, transported, sold, or used in orientations other than that described and shown here.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is an isometric view of a tension mounting assembly comprising a rail and a tension mount assembly, the mounting assembly being viewed from an underside;

FIG. 2 is an isometric view of the mounting assembly of FIG. 1, viewed from an upperside;

FIG. 3 is an isometric view of the mounting assembly of FIG. 1, viewed from an underside;

FIG. 4 is a side view of the mounting assembly of FIG. 1;

FIG. 5 is an end view of the mounting assembly of FIG. 1, and FIG. 5A is a detail view taken from this FIG. 5;

FIG. 6 is an exploded view of the mounting assembly;

FIG. 7 is an exploded view of the mount assembly;

FIG. 8 is a side view of the mount assembly;

FIG. 9 is an underside view or the mount assembly;

FIG. 10 is a cross-sectional view taken at B-B of FIG. 8;

FIG. 11 is an isometric view of a base of the mount assembly viewed from an upperside;

FIG. 12 is an isometric view of the base of the mount assembly viewed from an underside;

FIG. 13 is a cross-sectional view taken lengthwise through the mount assembly;

FIG. 13a is a cross-sectional view taken lengthwise through a mount assembly comprising a deeper socket than that of FIG. 13;

FIG. 14 is an isometric view of a load bearing support from the base of the mount assembly;

FIG. 15 is an isometric view of a mount portion of the mount assembly;

FIG. 16 is a cross-sectional view through the mount portion of the mounting assembly;

FIGS. 17 and 18 are isometric views of a rigid portion of the mount portion;

FIG. 19 illustrates the nut assemblies in their insertion position;

FIG. 20 illustrates the nut assemblies in their engagement, or ‘in-use’ position;

FIG. 21 is an isometric view of a nut assembly viewed from an upperside;

FIG. 22 is an isometric view of the nut assembly viewed from an underside;

FIG. 23 is an exploded view of the nut assembly;

FIG. 24 is a cross-sectional view through the mounting assembly illustrating the nut assemblies in their insertion position;

FIG. 25 is an end view of the mounting assembly illustrating the nut assemblies in their insertion position;

FIG. 25A is a detail end view of the nut assembly in its insertion position relative to the rail;

FIG. 25B is a detail isometric view of the nut assembly in its insertion position relative to the rail;

FIG. 26 is a side view of the mounting assembly illustrating a range of movement of the stem of the mount portion in the case of a seismic event;

FIG. 27 is a cross-sectional view through the mounting assembly illustrating the nut assemblies in their in-use position;

FIG. 28 is an end view of the mounting assembly as it may appear post a fire event;

FIG. 29 is a side view of the mounting assembly as it may appear post a fire event;

FIGS. 30 and 31 are isometric views of a mount rigid portion according to a further form; and

FIG. 32 is an isometric view of a mount portion comprising the rigid portion of FIGS. 30 and 31.

### DETAILED DESCRIPTION

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

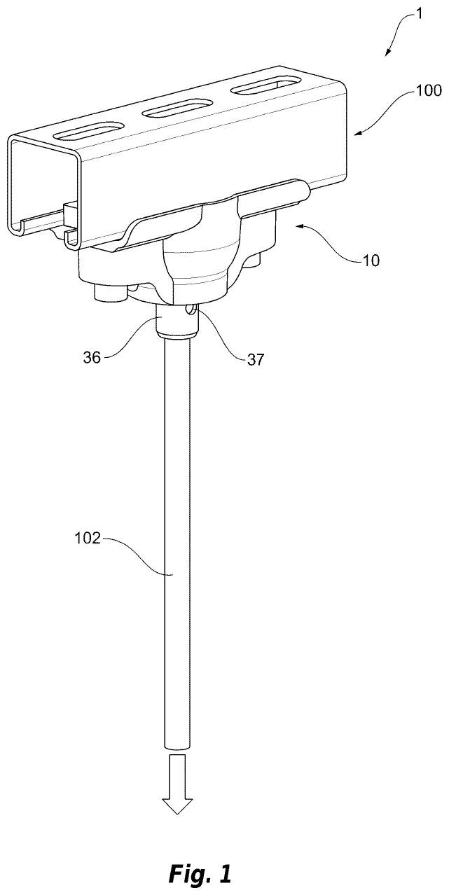

Referring now to FIG. 1, there is illustrated a mounting assembly 1 comprising a mount assembly 10, and a rail 100 (only a portion of a length of which is illustrated) for securement with respect to a structural ceiling, and from which the mount assembly 10 depends (by hanging), and with respect to which a base portion 20 of the mount assembly 10 is adapted to slide, so that the mount assembly 10 can be positioned therealong as required.

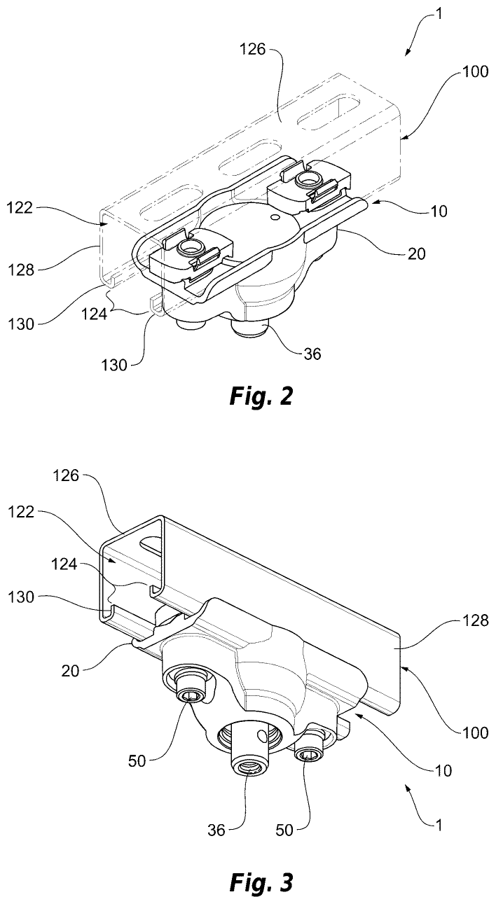

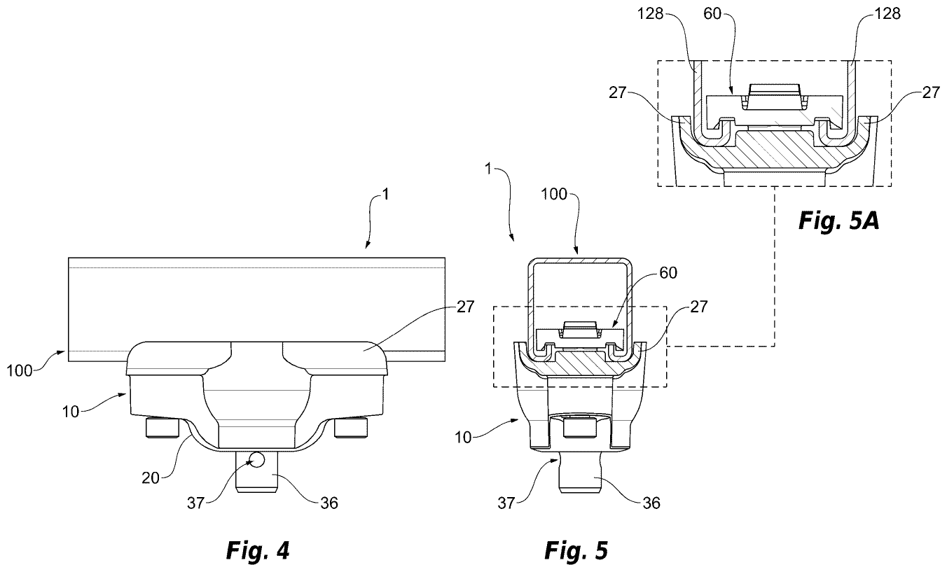

With reference to FIGS. 2 and 3, it can be seen that the rail 100 comprises a channel 122 comprising a slot 124, and a substantially constant cross-sectional shape throughout its length. This cross-sectional shape comprises a base 126, a pair of opposing sides 128, and an inwardly directed and downwardly curled lip 130 depending from each of the opposing sides 128.

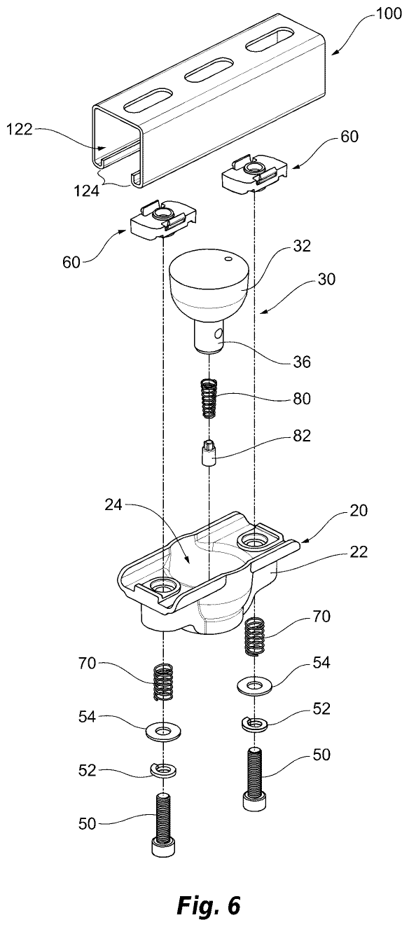

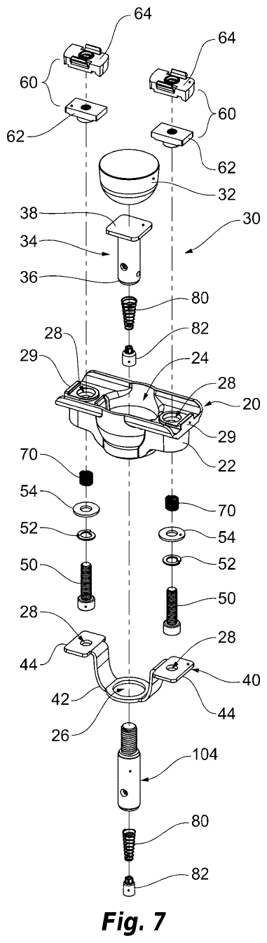

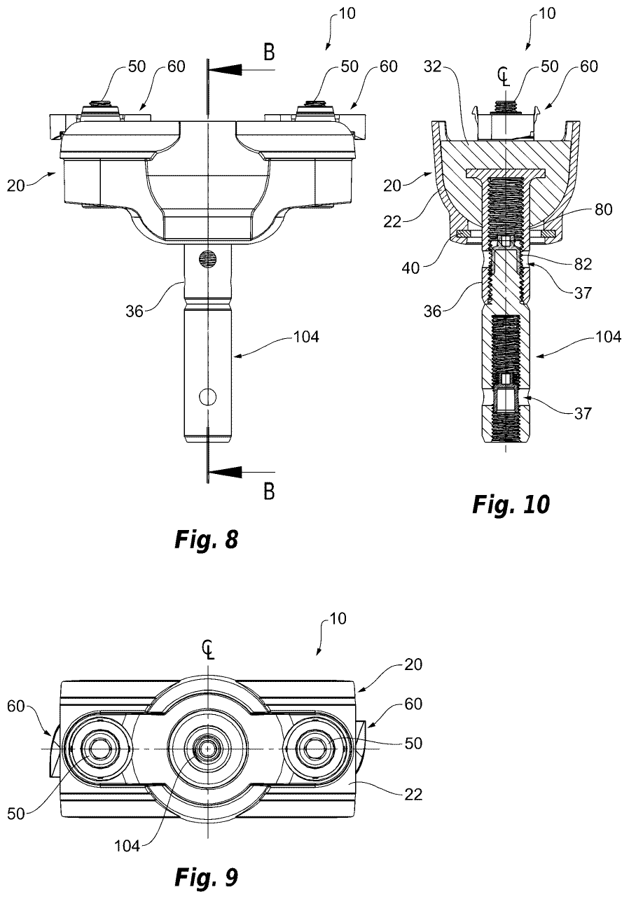

The mount assembly 10 comprises at least the base portion 20 and a mount portion 30 (see FIGS. 6 and 7). A mounting rod 102 for a load will either depend from the mount portion 30 directly, or via an adaptor 104 for a mounting rod or a different size.

The base portion 20 comprises a body 22 comprising an upperside and an underside, the upperside comprising a socket 24 of bulbous shape, and more particularly a hemispherical shape in this case formed therein, and the body 22 further comprising a through aperture 26 in the socket 24 extending between the upperside and the underside of the body 22. Body 22 further comprises a pair of side skirts 27, which in use, extend on either side of the rail 100, to resist rotation of the body 22 relative to the rail 100, and increase stability of the mount assembly 10.

The base portion 20 further comprises a load bearing support 40 encapsulated in a cushioning material (in this case a polyamide) from which the body 22 is formed, both of which cooperatively form the through aperture 26 extending between the upperside and the underside of the body 22.

The load bearing support 40 for the base portion 20 comprises a rigid, non-flammable metal bracket, the load bearing support 40 comprising a central portion 42 of a U-shape, and a pair of side tabs 44 extending to either side of the central portion 42. The U-shaped central portion 42 extends beneath the socket 24. and the side tabs 44 extend to either side of the socket 24.

The mount portion 30 comprises an end portion 32 having a bulbous shape, and more particularly a hemispherical shape in this case, and a stem 36 extending from the end portion 32.

The mount portion 30 further comprises a rigid, non-flammable body 34 of metal in this case, the rigid body 34 comprising the stem 36, which transitions via a radius fillet into an enlarged end portion 38, in this case an end plate 38, so sized as to be unable to pass through the through aperture 26 in the base portion 20 while the stem 36 does so. The end plate 38 and a portion of the stem 36 are encapsulated in a cushioning material (in this case a rubber), where it is this cushioning material that forms the bulbous end portion 32.

The end portion or plate 38 comprises a rectilinear planform, for the purpose of providing a resistance to rotation of the rigid body 34 with respect to the end portion 32.

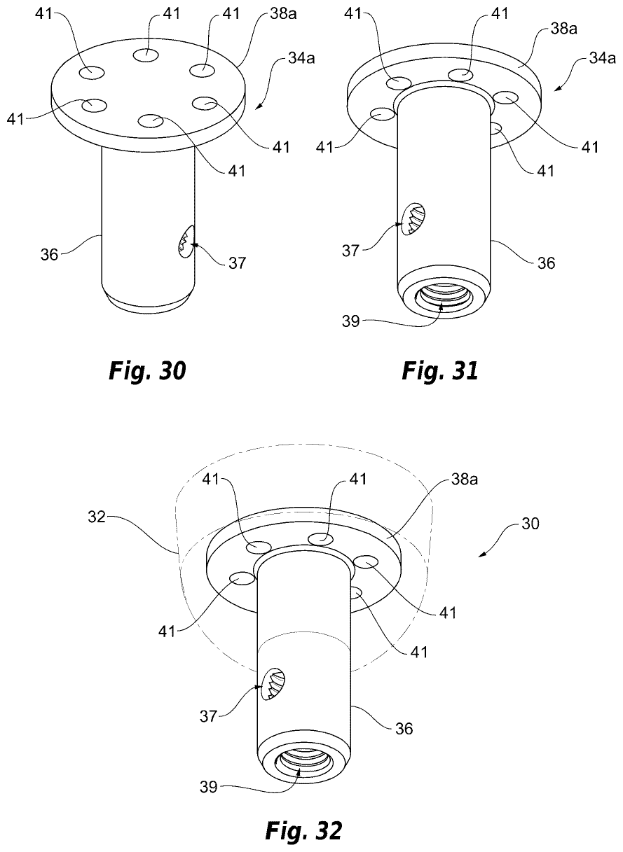

Referring now to FIGS. 30 through 32, there is illustrated a rigid body 34a for the mount portion 30, according to a further, alternate form. In this case, the end plate 38a is circular (as distinct from rectilinear end plate 38) comprising a plurality of apertures 41 therethrough (although one may suffice). In use, the cushioning material that forms the bulbous end portion 32 is moulded through the apertures 41, for the purpose of providing a resistance to rotation of the rigid body 34a with respect to the end portion 32.

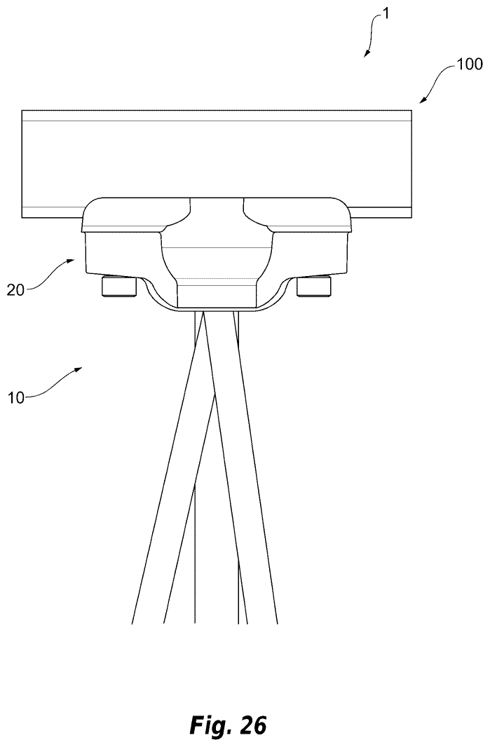

In use, the bulbous end portion 32 of the mount portion 30 nests in the socket 24 of the base portion 20 while the stem 36 extends through the through aperture 26 in the socket 24, the through aperture 26 being sized to provide a clearance around the stem 36. Advantageously, this ball in socket arrangement will permit a considerable range of relative pivoting movement between the mount portion 30 and the base portion 20 of the mount assembly 10 (as illustrated in FIG. 26), where this relative pivoting movement will aid the ability of the mounting assembly 1 to move with and thus withstand seismic events without failing in the way a rigid part might.

Moreover, by forming each of the base portion 20 and the mount portion 30 using cushioning materials over-moulded on structural elements, the mount assembly 10 will aid in the absorption of shock and vibration, further aiding performance during seismic events.

Referring now to FIGS. 28 and 29, in the event of a fire, these cushioning materials may be burned away, but even if they are, the end plate 38 of the non-flammable mount portion 30 will be retained by the non-flammable load bearing support 40 of the base portion, on account of it being too large to pass through the through aperture 26, and thus preventing the load hanging from the mount portion 30 from being dropped by the mounting assembly 1.

The base portion 20 further comprises a pair of bolt holes 28 extending therethrough between the upperside and the underside of the body 22, there being one bolt hole 28 to either side of the socket 24. These bolt holes 28 extend through both the cushioning material, and the side tabs 44 of the load bearing support, or bracket 40.

The mount assembly 10 further comprises a pair of bolts 50, and for each bolt a nut assembly 60, where the bolts 50 extend shank-first from an underside of the body 22 of the base portion 20 through the bolt holes 28, and where each bolt 50 is secured by a nut assembly 60 positioned on the upperside of the body 22 of the base portion 20. Each of a spring washer 52, a flat washer 54 and a compression spring 70 is disposed over the shank of each of the bolts 50 and between the head of each bolt 50 and the load bearing support 40 for the base portion 20.

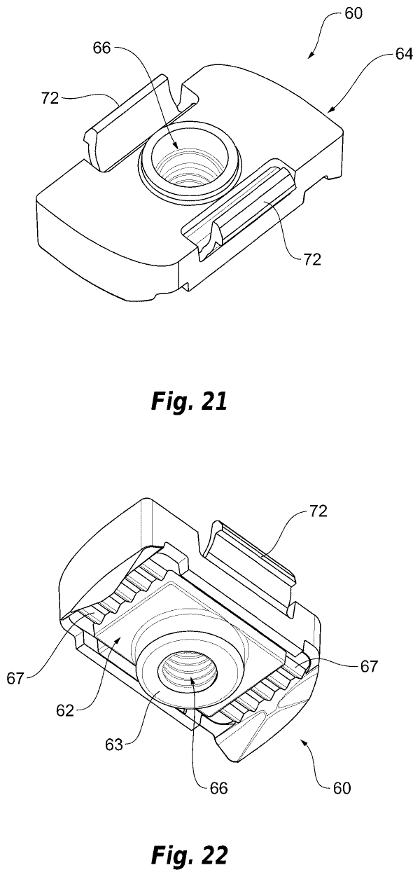

With reference to FIGS. 21 through 23, each of the nut assemblies 60 comprises a nut 62, and a nut cover 64.

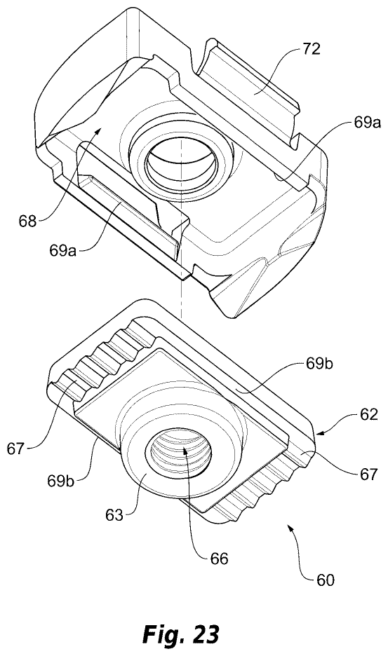

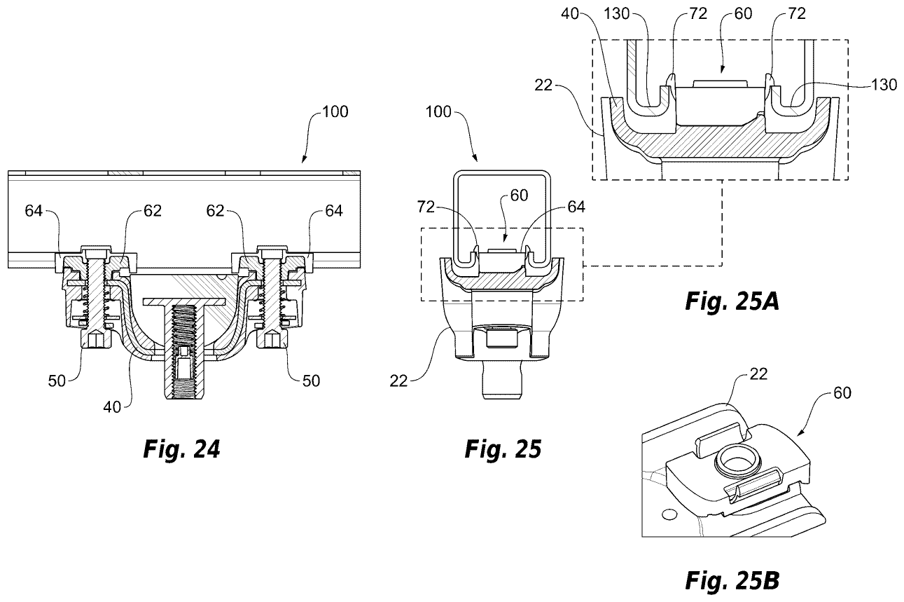

Each of the nuts 62 comprises a rectilinear planform body of metal, the body comprising a pair of end edges, a pair of longer side edges, an upperside, an underside, a boss 63 on the underside. and a threaded through hole 66 extending between the upperside and the underside and through the boss 63 for receiving the shank of one of the bolts 50. Each of the nuts 62 comprises a stepped recess 67 extending along the shorter side edges on the underside of body of the nut 62. As can be seen in FIG. 23, the underside of the nut 62 comprises rows of teeth to help it grip onto the rail 100 when the nut 62 and bolt 50 is tightened during assembly.

The end edges of the body of the nut 62 are shorter than the slot 124 defined between the lips 130 of the rail is wide, whereas the longer side edges are longer than the slot 124 defined between the lips 130 of the rail 100 is wide.

Each nut cover 64 comprises a body of a plastic material which is adapted to nest over the top of the nut 62, and retain the nut 62. An underside of the nut cover 64 comprises a recess 68 sized and shaped to receive the nut 62 therein, where each of the longer side edges of this recess comprise a retaining lip 69a, which in use, is received with a snap-fit in a receiving groove 69b provided along an underside, longer side edge of the nut 62, and which is adapted for this purpose accordingly. Optionally, the nut cover 64 could be overmolded onto the nut 62.

Each of the upperside, longer side edges of the nut cover 64 comprises one of a pair of upwardly and outwardly extending cantilever snaps 72 extending upwardly therefrom.

The slightly elongated dimensioning of the nut assembly 60 means that when the nut assemblies 60 are orientated such that their direction of elongation is aligned with the direction of elongation of the slot 124, then the nut assembly 60 can be inserted into the slot 124 and pass between the lips 130 of the rail 100. This orientation will hereinafter be referred to as an insertion position of the nut assemblies 60.

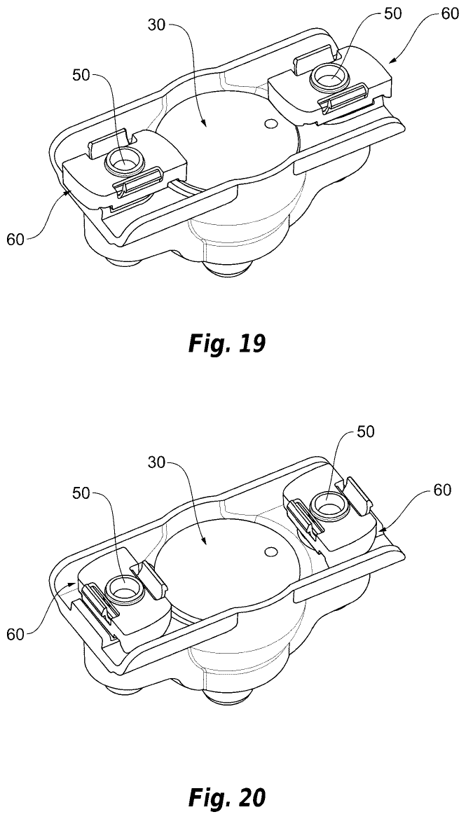

With reference to FIGS. 19, 25 and 25a, it can be seen that when in the insertion position, the cantilever snaps 72 can be employed to engage the nut assemblies 60 with the lips 130 of the rail 100 for the purpose of temporarily suspending the mount assembly 10 from the rail 100 via the cantilever snaps 72 during installation. This means that an installer need not have one hand tied up supporting the mount assembly 10 for longer than is necessary to snap-fit the cantilever snaps 72 between the lips 130 of the rail 100, and that the installer can have both hands free for completion of installation.

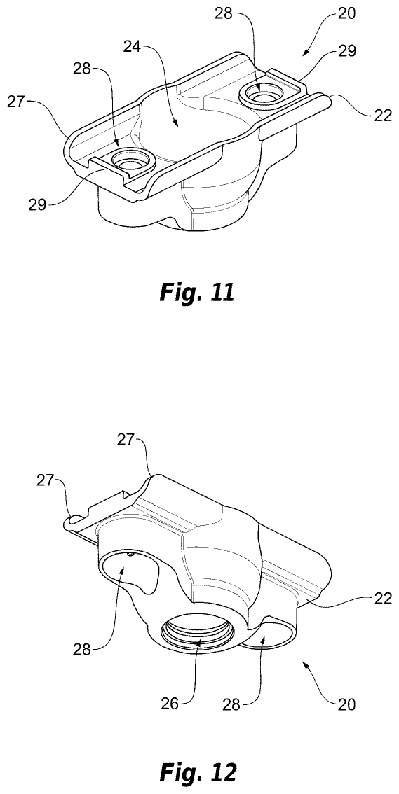

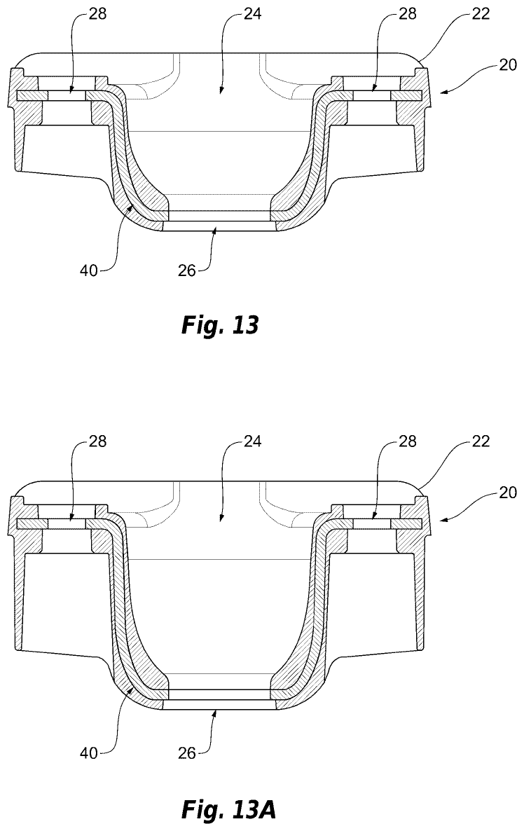

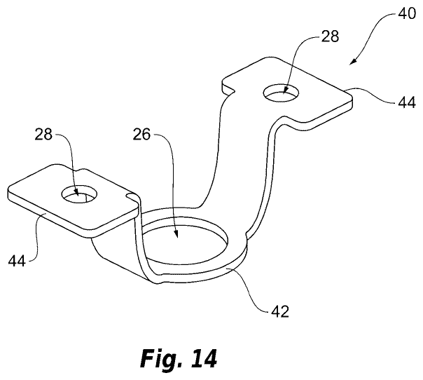

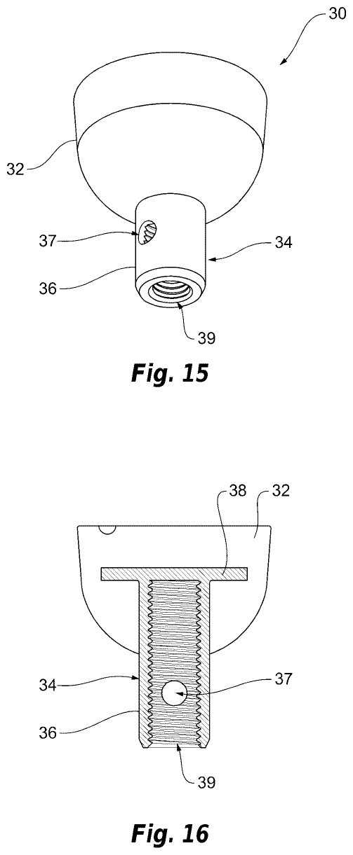

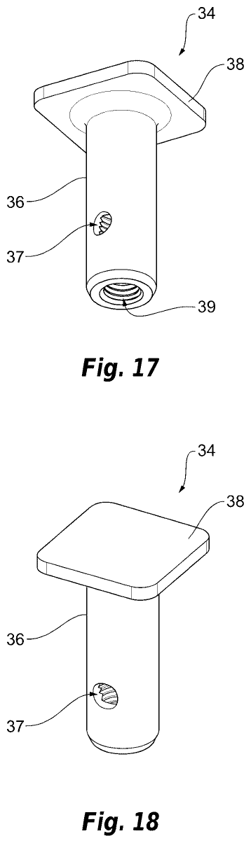

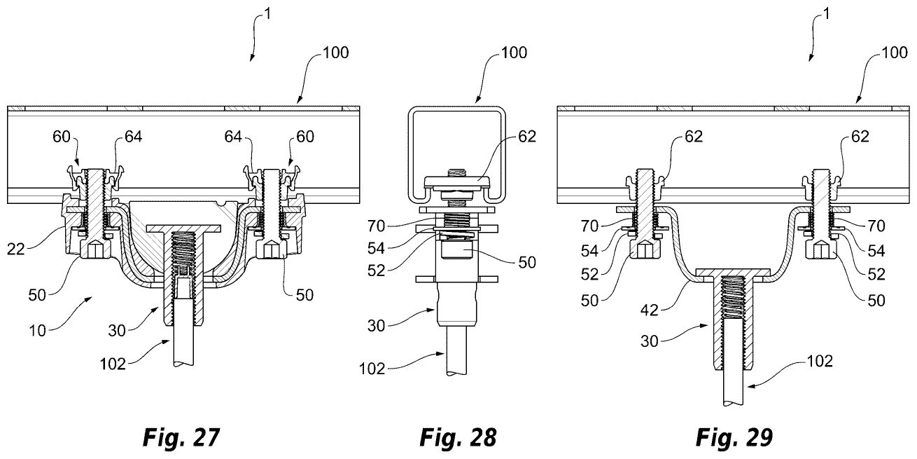

From this insertion position, each of the nut assemblies 60 can be rotated through 90° around the bolt 50 axis and using the boss 63 as a rotational guide, until they hit a stop 29 (see FIGS. 7 and 11), to a retained position (as illustrated in FIGS. 20, 27, 28 and 29) in which the stepped recesses 67 extending along the shorter side edges on the underside of the body of the nut 62 rest upon the lips 130 of the rail 100, ensuring a hanging, sliding retention of the mount assembly 10 to the rail 100.

With reference to FIGS. 28 and 29, in the event of a fire, the nut covers 64 may be burned away, but even if they are, the non-flammable nuts 62 will be retained by the non-flammable rail 100 thus preventing the load hanging from the mount portion 30 from being dropped by the mounting assembly 1.

Referring once again to the rigid body 34 of the mount portion 30, and to FIGS. 6 and 7. The stem 36 of the mount portion 30 is cylindrical, and comprises a blind hole 38 extending inwardly from a stem end which is distal to the end plate 38, where this blind hole 39 comprises a female (or internal) thread for receiving a male (or external) threaded end of either a hanging rod or an adapter 104. Inside of this blind hole 39 there is retained a compression spring 80, from which there depends an indicator cap 82. Preferably, the indicator cap 82 will be brightly coloured, so as to ensure that this is clearly visible through the inspection aperture 37. In use, as either of the hanging rod or adapter are threaded into the blind hole-39, the installer should continue to feed the threaded end of either the hanging rod or adapter into the stem end until the indicator cap 82 is no longer visible through the inspection aperture 37. In this way, the mount assembly 10 provides a means for indicating to the installer that either the hanging rod or adapter are sufficiently engaged as to be safe and secure in both seismic and fire events.

Where required, an adapter 104 can be employed to connect a hanging rod of different size to the stem 36 of the mount portion 30. Such an adapter 104 will comprises an elongate cylindrical body comprising a first end comprising a male thread sized to cooperate with the female thread inside of the stem 36, and a second, distal end comprising a blind hole 39 comprises a female (or internal) thread sized for receiving the threaded end of the dissimilarly sized hanging rod.

In the same way as the stem 36 of the mount portion 30, the adapter may comprise a compression spring 80, from which there depends an indicator cap 82 inside of the threaded blind hole 39. Similarly then, the adapter 104 provides a means for indicating to the installer that the hanging rod screwed into the adapter 104 is sufficiently engaged as to be safe and secure in both seismic and fire events.

It should be apparent that both the tension mount assembly and the tension mounting assembly, of which the mount assembly forms a part, are adapted to resist any failure which may result in dropping a load suspended therefrom in either or even both of a seismic and/or a tire event.

In the foregoing description, specific details are set forth to provide a thorough understanding of exemplary embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 10% of the stated value. For the purposes of the present disclosure, the phrase “at least one of A and B” is equivalent to “A and/or B” or vice versa, namely “A” alone, “B” alone, or “A and B.” Similarly, the phrase “at least one of A, B, and C,” for example, means (A), (B), (C), (A and B), (A and C), (B and C), or (A, B, and C), including all further possible permutations when greater than three elements are listed.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

The embodiments of the invention in which an exclusive property or privilege is claimed are defined as follows:

1. A tension mount assembly, comprising:
a base portion having a body, comprising:
an upperside and an underside, the upperside including a socket having a ball-like bulbous space formed therein; and
a through aperture in the socket extending between the upperside and the underside of the body; and
a mount portion which depends from the base portion by hanging, the mount portion comprising:
a rigid body formed from a non-flammable material and including a stem; and
an enlarged end portion which is encapsulated in a cushioning material which is shaped to provide a ball-like bulbous part form which nests in the socket of the base portion while the stem extends through the through aperture in the socket,
wherein the through aperture is sized to provide a clearance around the stem and is sized such that the enlarged end portion of the rigid body cannot pass through so the mount portion is not dropped by the base portion even if the cushioning material is consumed by a fire.

2. The tension mount assembly of claim 1, wherein the bulbous shape of the end portion of the mount portion comprises the shape of at least a portion of a sphere.

3. The tension mount assembly of claim 1, wherein the base portion further comprises a pair of bolt holes extending therethrough between the upperside and the underside of the body, and wherein each of the pair of bolt holes is positioned on opposite sides of the socket.

4. The tension mount assembly of claim 1, wherein the rigid body of the base portion comprises a load bearing support encapsulated in the cushioning material, and wherein the load bearing support and cushioning material are shaped to provide the socket and through aperture.

5. The tension mount assembly of claim 1, further comprising a pair of bolts, and for each bolt a nut, wherein the bolts extend shank-first from an underside of the body of the base portion through the bolt holes, and wherein each bolt is secured by one of the nuts positioned on the upperside of the body of the base portion.

6. The tension mount assembly of claim 5, wherein the mount assembly further comprises a compression spring disposed over the shank of each of the bolts and between the head of each bolt and the load bearing support for the base portion.

7. The tension mount assembly of claim 5, wherein each of the nuts comprises a rectilinear planform body of a non-flammable material, wherein the body comprises:
a pair of end edges;
a pair of longer side edges;
an upperside;
an underside;
a boss on the underside; and
a threaded through hole extending between the upperside and the underside and through the boss for receiving the shank of one of the bolts.

8. The tension mount assembly of claim 7, wherein each of the nuts comprises a stepped recess extending along the shorter side edges on the underside of the nut.

9. The tension mount assembly of claim 6, wherein for each nut there is a nut cover.

10. The tension mount assembly as in claim 9, wherein each nut cover comprises a body of a plastic material which is adapted to nest over the top of the nut and retain the nut.

11. The tension mount assembly of claim 10, wherein an underside of the nut cover comprises a recess sized and shaped to receive the nut therein, wherein each of the longer side edges of the recess comprise a retaining lip, which in use is received with a snap-fit in a receiving groove provided along an underside, longer side edge of the nut.

12. The tension mount assembly of claim 11, wherein each of the upperside, longer side edges of the nut cover comprises one of a pair of upwardly and outwardly extending cantilever snaps extending upwardly therefrom.

13. The tension mount assembly of claim 4, wherein the stem of the mount portion comprises a blind hole extending inwardly from a stem end which is distal to the end plate, wherein the blind hole contains a compression spring retained therein and from which there depends an indicator cap that is visible through an inspection aperture in the stem when the compression spring is unloaded.

14. The tension mount assembly of claim 1, wherein the bulbous space formed in the socket has a hemispherical shape.

15. A tension mounting assembly, comprising:
the tension mount assembly of claim 1; and
a rail upon which the tension mount assembly is adapted to slide.

16. The tension mounting assembly of claim 15, wherein the rail comprises a channel having a slot, and wherein both the channel and the slot extend in a direction of elongation of the rail.

17. The tension mounting assembly of claim 15, wherein the rail comprises a floor, a pair of opposing sides, and an inwardly directed lip depending from each of the opposing sides.

18. The tension mounting assembly of claim 15, wherein the tension mount assembly further comprises a pair of bolts, and for each bolt a nut, wherein the bolts extend shank-first from an underside of the body of the base portion through the bolt holes, and wherein each bolt is secured by one of the nuts positioned on the upperside of the body of the base portion, and
wherein each of the nuts is adapted to slidably engage in the slot of the rail so that the tension mount assembly is retained by the rail but permitted to slide therealong.

19. The tension mounting assembly of claim 15, wherein:
for each nut there is a nut cover;
each nut cover comprises a body of a plastic material which is adapted to nest over the top of the nut and retain the nut;
an underside of the nut cover comprises a recess sized and shaped to receive the nut therein, wherein each of the longer side edges of the recess comprise a retaining lip, which in use is received with a snap-fit in a receiving groove provided along an underside, longer side edge of the nut;
end edges of the nut are shorter than the slot defined between the lips of the rail is wide; and
the longer side edges of the nut are longer than the slot defined between the lips of the rail is wide so the nut can pass through the slot when its direction of elongation is aligned with a direction of elongation of the slot, and the nut engages the lips of the rail when the direction of elongation is transverse to the direction of elongation of the slot.

20. The tension mounting assembly of claim 19, wherein each of the upperside, longer side edges of the nut cover comprises one of a pair of upwardly and outwardly extending cantilever snaps extending upwardly therefrom, and wherein the cantilever snaps are adapted to engage the nut assemblies with the lips of the rail for the purpose of temporarily suspending the mount assembly from the rail via the cantilever snaps during installation.
